(19) United States
(12) Patent Application Publication
(10) Pub. No.: US 2016/0070712 A1
(43) Pub. Date: Mar. 10, 2016

(54) Dynamically Modifying Geographical Search Regions

(71) Applicant: Fanvana Inc., Palo Alto, CA (US)

(72) Inventors: Swetha Prabhakar, Los Altos Hills, CA (US); Krishna Prabhakar, Los Altos Hills, CA (US); Srinivas Devadas, Lexington, MA (US)

(21) Appl. No.: 14/520,506

(22) Filed: Oct. 22, 2014

Related U.S. Application Data
(60) Provisional application No. 62/046,994, filed on Sep. 7, 2014.

(51) Int. Cl. G06F 17/30; H04L 12/58

(52) U.S. Cl. CPC G06F 17/3087; H04L 51/04

(57) ABSTRACT

A first search is executed to obtain a first set of search results corresponding to a first geographical search area. A determination is made that the first set of search results does not meet a search results criteria. A second geographical search region is dynamically selected for executing a second search in response to determining that the first set of search results does not meet the search results criteria. The second search is executed to obtain a second set of search results corresponding to the second geographical search area.

### FIELD

The present disclosure relates to executing searches to obtain search results associated with a geographical search region. Specifically, the present disclosure relates to dynamically modifying geographical search regions for executing searches based on search results for a previous search failing to meet a search results criteria.

### BACKGROUND

Software applications allow users to enter queries to search for data. For example, a user enters a query term “museums” using a mobile application executing on a cellular phone. The mobile application transmits the query term to a web server, which returns a list of web domains related to the query term “museums.”

Advancements in search technology allow users to specify a geographical location to obtain search results corresponding to the specified geographical location.

In an example, a user enters a query “museums near Palo Alto, Calif.” using an application executing on a desktop machine. The application transmits the query terms to a web server. The web server executes a search for museums near the user-specified location of Palo Alto, Calif. and finds at least the “Museum of American Heritage.” The web server returns information (e.g., full address or website) related to the “Museum of American Heritage”. The application then displays the information related to the “Museum of American Heritage” in the user-specified location of Palo Alto, Calif.

In another example, a user Amanda selects “male, age 35-40, height 5-10 to 6-4” as desired characteristics of a mate and a target location “San Francisco, Calif.” in a mobile application executing on a cellular phone. Based on the user-specified location of San Francisco, Calif., the mobile application executes a search to identify single males in San Francisco, Calif. of age 35-40 and height between 5-10 and 6-4. The mobile application then displays the search results to the user Amanda.

### BRIEF DESCRIPTION OF DRAWINGS

FIG. 1 shows a system with one or more computing devices in accordance with one or more embodiments.

FIG. 2A illustrates operations in accordance with one or more embodiments.

FIG. 2B and FIG. 2C illustrate an example of modifying a geographical search region in accordance with one or more embodiments.

FIG. 3 shows a computing system in accordance with one or more embodiments.

### DETAILED DESCRIPTION

The present disclosure may be best understood by referring to the following description used to illustrate embodiments of the present disclosure. Numerous specific details are set forth in order to provide a more thorough understanding. However, it will be apparent to one of ordinary skill in the art that embodiments may be practiced without these specific details. In other instances, well-known features have not been described in detail to avoid unnecessarily complicating the description. Any combination and/or order of components and/or operations described herein may be used to implement one or more embodiments. Certain components and/or operations may be entirely skipped. Like elements in the various figures are denoted by like reference numerals for consistency.

TABLE OF CONTENTS

| | |
|---|---|
| A. | OVERVIEW . . . 6 |
| B. | SYSTEM ARCHITECTURE EXAMPLE . . . 7 |
| C. | SELECTION OF A GEOGRAPHICAL SEARCH REGION . . . 9 |
| D. | EXECUTING A SEARCH TO OBTAIN A SET OF SEARCH |
| | RESULTS CORRESPONDING TO THE GEOGRAPHICAL |
| | SEARCH REGION . . . 12 |
| E. | DETERMINING WHETHER THE SEARCH RESULTS |
| | CORRESPONDING TO THE GEOGRAPHICAL SEARCH |
| | REGION MEET A SEARCH RESULTS CRITERIA . . . 14 |
| F. | DYNAMICALLY MODIFYING THE GEOGRAPHICAL |
| | SEARCH REGION IF THE SEARCH RESULTS CRITERIA IS |
| | NOT MET . . . 16 |
| G. | REPEATING THE DYNAMIC MODIFICATION OF THE |
| | GEOGRAPHICAL SEARCH REGIONS . . . 19 |
| H. | DYNAMICALLY REMOVING, MODIFYING, AND/OR |
| | ADDING SEARCH FILTERS . . . 20 |
| I. | FILTERING SEARCH RESULTS BASED ON LOCATIONS |
| | ASSOCIATED WITH SEARCH RESULTS . . . 21 |
| J. | OBTAINING USER INPUT FOR SELECTING USERS IN |
| | RESPONSE TO SEARCH RESULTS INCLUDING A SET OF |
| | USERS THAT DO NOT MATCH A SEARCH CRITERIA . . . 22 |
| K. | SYSTEM EXAMPLES . . . 23 |

A. Overview

In general, in one aspect, embodiments relate to operations for executing a search to obtain search results corresponding to a first geographical search region, and in response to determining that the search results do not meet a search results criteria, dynamically selecting a second geographical search region to execute another search.

In general, in one aspect, embodiments relate to identifying a first geographical search region to search for users that match search criteria; determining that a number of users, corresponding to the first geographical search region and matching the search criteria, do not meet a threshold value; and responsive to the determining operation, dynamically modifying the geographical search region to execute at least a second search for users that match the search criteria.

In general, in one aspect, embodiments relate to identifying a plurality of users that match search criteria; selecting a subset of the plurality of users that are located within a particular travel distance from a particular location(s), and/or within a particular travel time from the particular location(s); and transmitting information identifying the subset of the users.

In general, in one aspect, embodiments relate to identifying a first geographical search region to search for venues that match search criteria; determining that a number of venues within the first geographical search region that match the search criteria do not meet a threshold value; and responsive to the determining operation, dynamically modifying the geographical search region to execute at least a second search for venues that match the search criteria.

Other embodiments will be apparent from the following description and the appended claims.

B. System Architecture Example

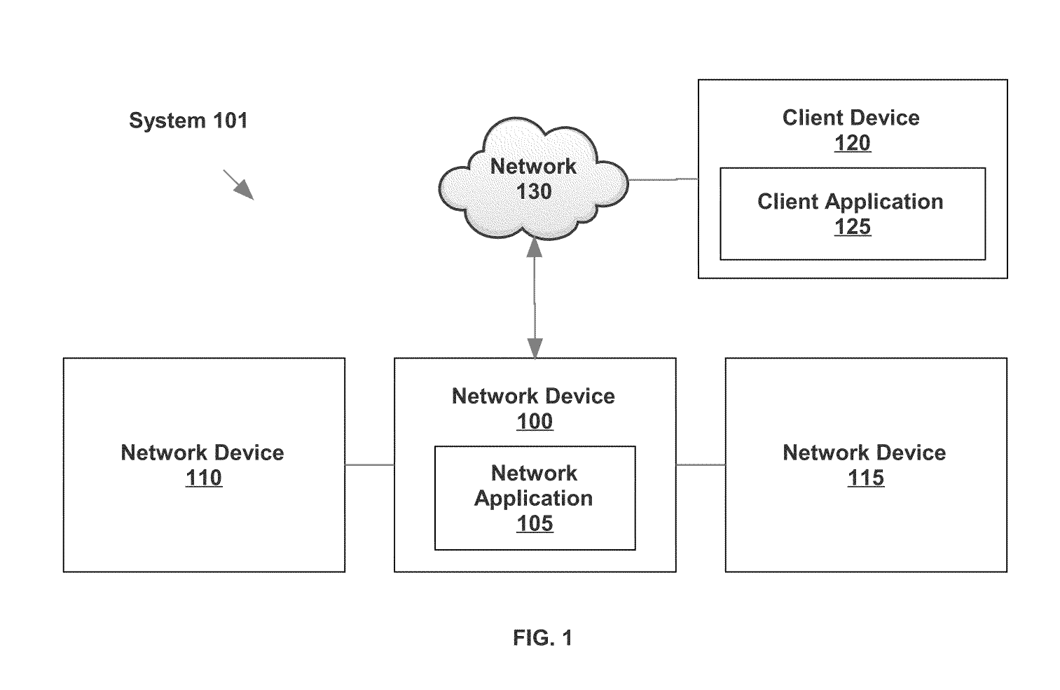

FIG. 1 shows a system (101) with one or more computing devices in accordance with one or more embodiments. Computing devices include one or more network devices (e.g., network device (100), network device (110), and network device (115)), and one or more client devices (e.g., client device (120)). A network application (105) is executing on network device (100) and a client application (125) is executing on the client device (120).

Examples of client devices (120) include laptop computers, smart phones, personal digital assistants, tablets, desktop computers, and any other device used by a user. The client device (120) is capable of wireless and/or wired communication with other devices.

In one embodiment, the client device (120) is communicatively coupled to network device (100) via a network (130). Network (130) represents a direct connection, a Local Area Network (LAN), and/or the Internet. The client device (120) is associated with one or more permissions needed for communication with the network device (100).

In an embodiment, client device (120) includes software associated with a Global Positioning System that identifies the geographical location of the client device (120). The client device (120) includes other features, components, and/or functionality of typical or atypical client devices not explicitly described herein.

In one embodiment, client application (125) is a mobile application executing on the client device (120) configured to perform one or more operations described herein.

In one example, client application (125) is an application for obtaining and displaying information to the user. The client application (125) obtains data via user input from a user, from other user applications executing on the client device (120), or via an operating system executing on client device (120).

The client application (125) communicates with network applications (e.g., network application (105)) executing on one or more network devices (e.g., network device (100)), other client applications executing on the client device (120), and/or other client applications executing on other client devices (not shown).

Operations requested by a user are completed in part or in whole by the client application (125). For example, the client application (125) (a) accesses a local database on the client device (120) to execute a query requested by a user and/or (b) accesses a remote database on network device (100) to execute the query.

In one or more embodiments, each network device (100, 110, and 115) is a hardware device that is configured to receive packets from a client device (120) and/or transmit packets to the client device (120). In an example, network device (100) is a web server that executes a query received from the client device (120) and provides search results to the client device (120). A network device refers to a server, an access point, a controller, a storage device, or any other device directly or indirectly communicating with client device (120).

Examples described herein refer to a specific application or specific device performing a particular operation, however, other applications and/or devices may instead perform the operations.

C. Selection of a Geographical Search Region

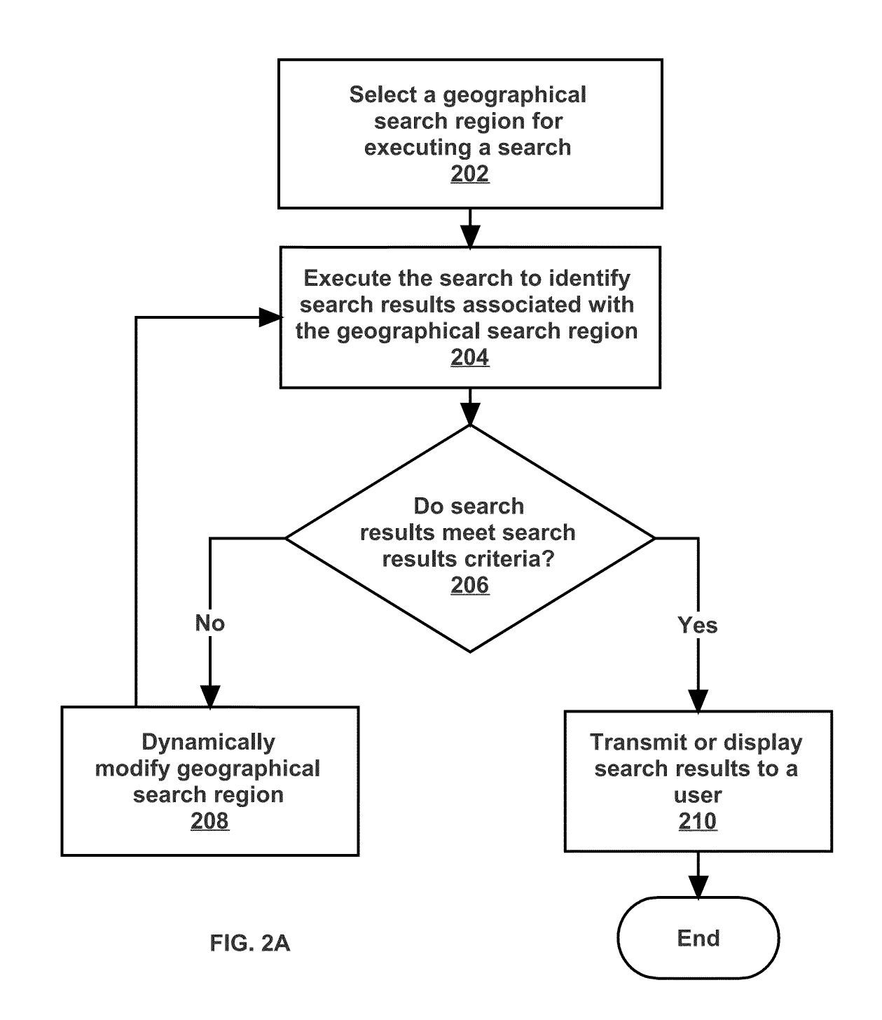

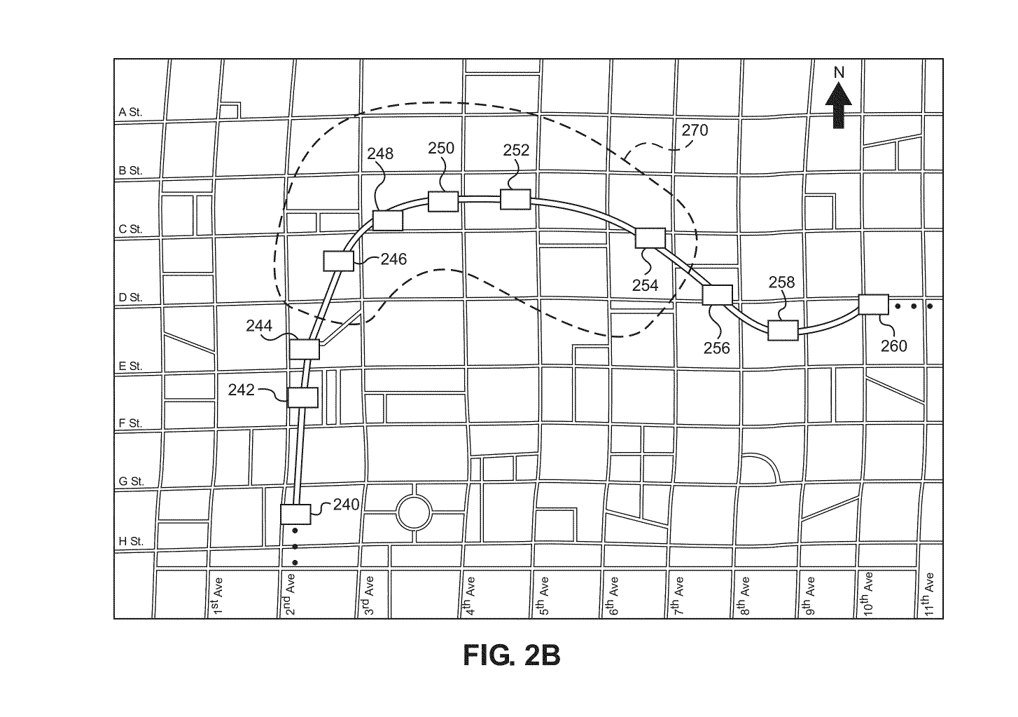

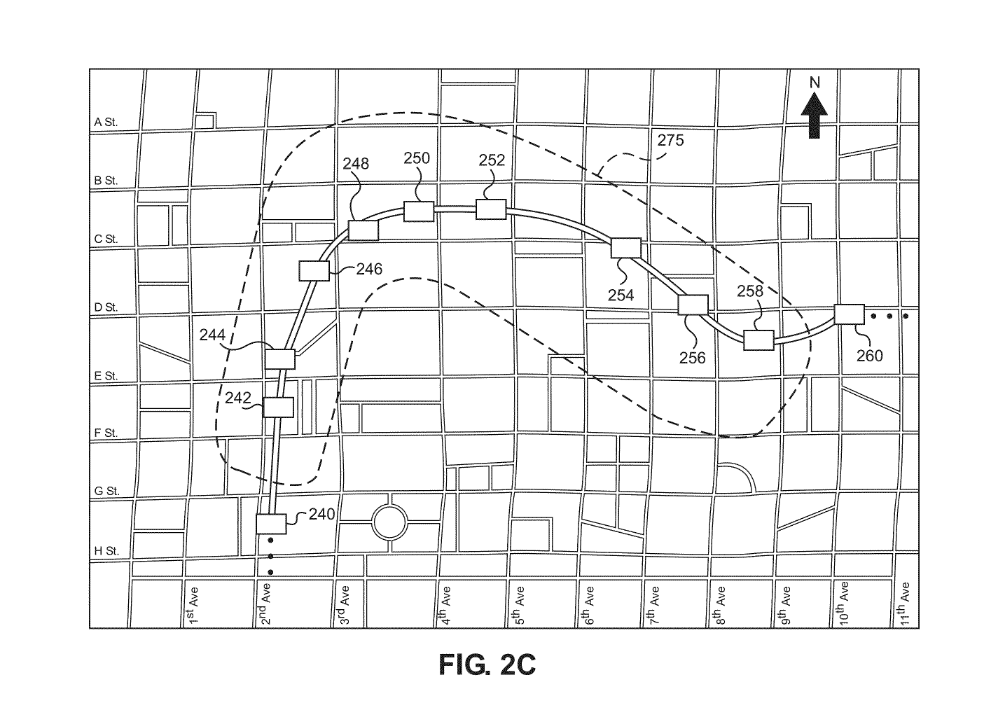

FIG. 2 illustrates operations in accordance with one or more embodiments. Operations described herein may be re-ordered and/or skipped. Operations not described herein may be added.

In one or more embodiments, a geographical search region is selected for executing a search to identify search results that are associated with the geographical search region (Operation 202). The geographical search region for an initial search is selected by a computing system and/or a user. The geographical search region refers to a single contiguous region or multiple non-contiguous regions.

In an embodiment, the geographical search region is defined with respect to travel time and/or travel distance from one or more other locations. In an example, the geographical search region includes all locations within a ten-minute travel time from a user's favorite bar. In another example, the geographical search region includes all locations within a five-mile travel distance from the user's home address. In yet another example, the geographical search region includes locations within a radius of eight miles from a football stadium. In one example, the geographical search region includes all locations within a ten-mile travel distance from any venue associated with a user's interests (e.g., user's favorite sports teams).

In an embodiment, the geographical search region is defined with respect to travel cost. All locations reachable from one or more other locations using a maximum travel cost are included within the geographical search region. In an example, a total travel budget of $20 is used to define the geographical search region. The geographical search region includes locations within a $20 taxi ride.

In an embodiment, the geographical search region is defined with respect to a mode of transportation. In an example, the geographical search region includes locations reachable from a user's work address using a public transportation system or a ride-sharing transportation program. In another example, the geographical search region includes locations reachable via a bicycle from a user's home address. In an example, the geographical search region includes locations reachable with the user's specific vehicle and two gallons of gasoline (e.g., computed based on mpg for the user's vehicle). In an example, the geographical search region includes locations reachable via a user's electric car based on the range of the electric car per full charge. The modes of transportation used for determining the geographical search region are specified in a user profile.

In an embodiment, the geographical search region is defined with respect to a current time of day or day of week. In an example, the geographical search region is twenty miles from a user's home if the search is executed before 4 pm and five miles from the user's home if the search is executed after 4 pm.

In an embodiment, the geographical search region is defined with respect to a future time of day or future day of week that is relevant to the search criteria. In an example, a first San Antonio Spurs fan searches for a second San Antonio Spurs fan with whom to watch a particular San Antonio Spurs basketball game that is to be broadcasted on Sunday, Sep. 21, 2014 from approximately 11 am Pacific Standard Time to 3 pm Pacific Standard Time. The system determines a user profile indicating that the user is willing to travel up to ten miles to any venue from home before 5 pm and only five miles to any venue from home after 5 pm on Sundays. Responsive to determining that the user would travel approximately between 10:30 am to 11 am and again between 3 pm to 3:30 pm to watch the game with another San Antonio Spurs basketball game, the system searches for other users within ten miles from the first San Antonio Spurs fan's home.

In an embodiment, the geographical search region is selected based on a current user state or future user state. In an example, the user state includes one or more preferences, accessibility values, and/or availability values for the user. The user state indicates that the user is in a home mode and the corresponding travelling preferences and/or capability is indicated in a home profile for the user. Alternatively, the user state indicates that the user is in a travel mode and the travelling preferences and/or capability is indicated in a travel profile for the user.

In an embodiment, the geographical search region for a search corresponds to a zip code, area code, city, town, or other partition defined by a governmental entity. In an example, a user enters “Vega, Texas” as a geographical search region as part of a query to search for shoe stores. In an example, a geographical search region is defined by latitude values and longitude values.

In an embodiment, a geographical search region is determined by a computing system based on interests, patterns, or behavior of a user. In an example, a geographical search region is defined based on locations previously visited and/or frequently visited by a user. A computing system determines a distance that a user typically travels to go to sports bars. The computing system then identifies a geographical search region to include locations that are within the typical travel distance from the user's home.

In one embodiment, a geographical search region excludes certain regions specified by a user or determined by a computing system. For example, a geographical search region includes all locations within a ten-mile travel distance from a user's favorite restaurant with the exception of a high crime area that is within ten miles from the user's favorite restaurant.

D. Executing a Search to Obtain a Set of Search Results Corresponding to the Geographical Search Region

In one or more embodiments, a search is executed to obtain a set of search results corresponding to the geographical search region (Operation 204). The search is initiated by a user or by a computing system. The search is executed periodically or continuously to update a set of search results.

In an embodiment, a search is executed using a local database. In an example, a user enters a query “restaurant near San Jose, Calif.” on a desktop machine. The desktop machine accesses a local database, implemented on the desktop machine, including restaurants with corresponding locations. The desktop machine identifies restaurants located in San Jose, Calif. to generate a first set of search results.

In an embodiment, a search is executed using a remote database. In an example, the user enters a query “Sports Bar for Lakers fan near Houston, Tex.” in a mobile application executing on the user's cellular phone. The mobile application provides the query terms to a web server. The web server identifies a first set of search results including two bars in Houston, Tex. known to be associated with Los Angeles Lakers' fans. The association between the bars and the Lakers basketball team is created based on input from the bars and/or from users who have patronized the bar.

In an embodiment, the search is executed for a query that is defined by a user and/or a query that is defined by a computing system. In an example, the query defines the characteristics of users and the geographical search region. The query submitted by a user living in Phoenix, Ariz. includes “San Francisco 49ers Fans.” The geographical search region of Phoenix, Ariz. is selected for executing the search by a computing system based on user's residence address in Phoenix, Ariz. or a determination that the IP address corresponding to the user's client system is associated with Phoenix, Ariz. The search results include three individuals that are San Francisco 49ers fans who live in Phoenix, Ariz.

In an embodiment, a search is executed to find other users that (a) are associated with at least one location in the geographical search area and (b) match particular search criteria. In an example, a search is executed to find all New York Yankees fans within one block of Times Square that are available to watch baseball games on Tuesday nights. The search identifies two users.

In an example, a search is executed for “baby cribs under $200” within five miles of a user's home at 345 Broadway St. in Atlanta, Ga. A search for stores that sell baby cribs and are located within five miles of the user's home results in identification of three stores. However, of the three stores, only one store includes a baby crib under $200. Accordingly, search results identified by the computing system that match the particular search criteria and the geographical search region include only one store.

In an example, a search for “democratic party events” is initiated by a user in Washington, District of Columbia without specifying a geographical search region. A network device obtains a current location of the user's client device that is determined via a Global Positioning System (GPS). The network device then executes a search for “democratic party events” within one mile of the user's current location to identify four upcoming events.

E. Determining Whether the Search Results Corresponding to the Geographical Search Region Meet Search Results Criteria

In one or more embodiments, search results corresponding to (a) particular search criteria and (b) a geographical search region are compared to (c) search results criteria to determine if the search results meet the search results criteria (Operation 206). A determination is made that the search results meet the search results criteria or that the search results do not meet the search results criteria. Search results criteria as referred to herein may include a single criteria or multiple criteria. Examples may refer to singular or multiple forms of search result criteria, however, both are applicable in various embodiments.

In an embodiment, the search results criteria define a minimum number of search results that must match the search criteria. In an example, a computing system determines that a search for stores, in a particular geographical search region, that sell baby cribs under $200 must yield at least two stores (i.e., search results criteria) to present as options to a user. If a search yields only one store selling baby cribs under $200 within the geographical search region, a determination is made that the search results do not meet the search results criteria of the minimum of two stores.

In another example, search results criteria define a minimum number of fans that must be found in a search for sports fans of a particular team. In an example, the search results criteria indicates that a minimum of five fans must be found when executing a search for New York Yankees fans that are available to watch baseball games on each of the upcoming three Tuesday nights. However, an initial search of New York Yankees fans within one block of Times Square identifies only four users. Accordingly, a determination is made that the search results do not meet the search results criteria.

In one embodiment, search results criteria identify one or more characteristics of the search results as a whole. The search results criteria define characteristics of users, venues, events, stores, etc. identified in the search results.

In an example, a search for sports fans is executed to group the sports fans into a suggested social group. The search results criteria for sports fans indicates that at least one of the users identified in a set of search results must be linked to a “host” profile indicating that the user is willing to host other users at his home for viewing games or has subscription to a televised sporting event.

In an example, the search results criteria define a total spending budget of users within the search results. The search results criteria for camping buddies defines a total minimum budget of $300 based on all the users' individual spending budgets. If a total spending budget of a set of users identified in a set of search results exceeds the minimum of $300, the search results criteria are met.

In an example, search results criteria defines a minimum number of male users and/or a minimum number of female users. A search is executed to find a group of friends (located within five miles of a user's home) to go with to a Salsa dancing club. The search results criteria defines a minimum number of three male users and three female users that must be included in the search results. If the identified group includes at least three male users and three female users, the search results criteria are met.

In an example, the search results criteria define a minimum of number of users with a particular characteristic. In an example, a search is executed for finding other users within a first geographical region to attend a football game with and tailgate with prior to the football game. The search results criteria indicates that at least one user in the search results has a car and that at least one user in the search results has a portable barbecue grill. If the users include at least one user with a car and at least one user with a portable barbecue grill, the search results criteria are met.

In an example, search results criteria define a minimum knowledge set and/or skill set among users in search results. In an example, a search is executed for finding other users to go camping with. The search results criteria indicate that at least one user must own a tent, at least one user must know how to assemble a tent, and at least one user must know the trails around the campground. If anyone skill identified in the search results criteria is not found in at least one user in the users identified in the search results, the search results criteria are not met.

F. Dynamically Modifying the Geographical Search Region if the Search Results Criteria is not Met

In one or more embodiments, when a prior set of search results, corresponding to a geographical search region, does not meet the search results criteria, the geographical search region is dynamically modified (Operation 208).

Dynamically modifying a geographical search region as referred to herein includes dynamically selecting a different geographical search region from a geographical search region used for a prior search. Examples of dynamically modifying a geographical search region include but are not limited to: adding additional geographical search regions to a prior geographical search region, replacing the prior geographical search region with a non-overlapping new geographical search region, selecting a subset of a prior geographical search region and adding an additional geographical search region.

In an embodiment, the geographical search region used for executing a search is modified automatically by a computing system in response to determining that the search results do not meet the search results criteria. The modification of the geographical search region is performed without asking a user to select a new geographical search region in response to determining that the search results from a prior search corresponding to a first geographical search region did not meet search results criteria.

In an example, a prior geographical search region that was defined to include locations within a five-mile travel distance from one or more other locations is modified to include locations within a seven mile travel distance from one or more other locations. In another example, a prior geographical search region that was defined to include locations within a fifteen-minute travel time from one or more other locations is modified to include locations within a twenty-minute travel time from one or more other locations.

In an example, a prior geographical search region, which included a first set of locations accessible via train, is modified to include an additional set of locations also accessible via bus.

In an example, a prior geographical search region, which included locations accessible from a particular location using a maximum $20 travel budget for a taxi, is modified to include locations accessible from the particular location using a maximum $25 travel budget for a taxi.

FIG. 2B and FIG. 2C illustrate an example of modifying a geographical search region to include an additional set of locations accessible via public transportation. Specifically, FIG. 2B illustrates a set of train stations including Jefferson Park Station (240), Montrose Station (242), Irving Park Station (244), Belmont Station (248), Logan Square Station (250), California Station (252), Western Station (254), Damen Station (256), Division Station (258), and Chicago Station (260). FIG. 2B further includes an initial geographical search region (270) near Chicago, Ill. that includes locations reachable within two stops in either direction along a train route from the Logan Square Station (250). A search is executed to identify Broncos fans residing within the initial geographical search region (270). In response to determining that a number of Broncos fans found within the initial geographical search region (270) did not meet a minimum number of fans indicated in the search results criteria, the initial geographical search region (270) is modified. A new geographical search region (275) is dynamically selected. FIG. 2C illustrates the new geographical search region (275) that includes locations reachable within four stops in either direction along the train route from the Logan Square Station (250).

In another example, locations accessible via a ride sharing program are included in a first geographical search region and additional locations accessible via the same ride sharing program are included in a second geographical search region.

In an embodiment, the geographical search region is modified based on user interests, behavior, or patterns. In an example, an initial geographical search region is based on a maximum distance a user travels on a weekly basis. A modified geographical search region is based on a maximum distance a user travels on a monthly basis. In another example, the geographical search region is initially based on a user's home address. In this example, the modified geographical search region is based on (a) the user's home address and the user's work address or (b) only the user's work address.

In an embodiment, a geographical search region used in a first search includes a town in which a particular user lives. A dynamically modified geographical search region includes the town in which the particular user lives and additional towns that neighbor the town in which the particular user lives.

In an embodiment, once the dynamically modified search region is determined, the process returns to Operation 204 in which the prior search is executed again using the dynamically modified search region instead of the initial search region to obtain an updated set of search results. In one example, re-executing the prior search includes executing the entire search again based on the modified search region. In another example, re-executing the prior search includes executing the search only to identify search results corresponding to locations that were not included in the initial geographical search region. Thereafter, the search results from both searches are combined to obtain the search results corresponding to the modified geographical search region.

Once a set of search results determined to match search results criteria is identified, the set of search results is transmitted and/or displayed to a user (Operation 210). In an example, a network device executing the searches transmits the updated set of search results to a client device for display to the user. In another example, a client device executing the searches directly displays the updated set of search results to the user.

In one example, operations 202-208 are performed by a single device (e.g., client device or network device). In another example, operations 202, 206, and 208 are performed by a client device and operation 204 is performed by a network device. In a third example, operation 202 is performed by a client device and operations 204-208 are performed by a network device.

G. Repeating the Dynamic Modification of the Geographical Search Regions

In one embodiment, the process of dynamically modifying a geographical search region based on search results not meeting search results criteria (operations 204-208) is repeated until the updated search results meet the search results criteria.

In an embodiment, a maximum limit is used for repeating operations 204-208. For example, a travel distance or travel time is dynamically modified and searches re-executed until the search results meet the search results criteria or until a maximum travel distance is reached or maximum travel time is reached. The maximum value (travel distance, travel time, travel budget, etc.) is determined by a computing system or specified by a user.

In an embodiment, a maximum number of modifications of the geographical search region is allowed. In an example, subsequent to dynamically modifying a geographical search region four times and executing five searches (initial search plus search after each modification), no additional modifications or searches are permitted. In this example, the last search results are presented to a user.

Other limitations on dynamically modifying geographical search regions, not explicitly mentioned herein, may be implemented.

H. Dynamically Removing, Modifying, and/or Adding Search Filters

In one embodiment, a use of geographical search region as a filter for search results is dynamically removed. A search is performed to identify New York Knicks fans located within fifty miles from a user's home address in Vega, Tex. The search identifies only two fans within fifty miles from the user's home address and the search results criteria requires at least five fans. In response to determining that an insufficient number of fans are found (i.e., search results do not meet search results criteria), the system removes the geographical location filter and identifies fans located anywhere.

In an embodiment, the system removes a first filter and adds a second filter in response to determining that search results found using the first filter did not meet the search results criteria. Continuing the example above, the system removes the restriction of fans being located within fifty miles from the user's home and instead adds the restriction of age. In this example, the user is forty three years old. The system searches for fans within the age group of forty years old to forty years old.

In another embodiment, the system modifies a first filter and adds additional filters in response to determining that the search results found using the first filter do not meet the search results criteria. In the example above, the system modifies the geographical search area from fifty miles within the user's home address to a hundred miles within the user's home address and adds the age filter to identify users that are near a similar age as the user.

I. Filtering Search Results Based on Locations Associated with Search Results

In an embodiment, a search is executed to identify a plurality of users that match particular search criteria corresponding to a particular user, the particular user being associated with at least one location. In an example, the at least one location is a home address, work address, or any address the user is expected to be at (e.g., address indicated in a schedule). The at least one location is selected based on a prior visit by the particular user to the at least one location. The at least one location is obtained via user input from the particular user.

A location associated with each user of the plurality of users is determined. A subset of the plurality of users that are associated with locations within a particular travel distance, within a particular travel time, and/or within a particular travel cost from the at least one location is identified. Data identifying the subset of the plurality of users is stored or transmitted.

In an example, the particular travel distance, the particular travel time, and/or the particular travel cost is determined based on a time of day and/or a day of a week corresponding to (a) an event associated with the search or (b) when the search was executed.

Identifying the subset of the plurality of users includes identifying the subset of the plurality of users that are accessible via one or more modes of transportation that are available to the particular user.

Embodiments include dynamically modifying filters when the search results using a prior set of filters do not meet a search results criteria. For example, any of the particular travel distance, particular travel time, and/or travel cost are dynamically modified to obtain an updated set of search results.

J. Obtaining User Input for Selecting Users in Response to Search Results Including a Set of Users that do not Match a Search Criteria

In one embodiment, a use of geographical search region as a filter for search results is dynamically removed. A search is performed to identify Phoenix Suns fans located within thirty miles from a particular user's home address in Truckee, Calif. The search identifies only one fan within thirty miles from the user's home address and the search results criteria requires at least three fans. In response to determining that an insufficient number of fans are found (i.e., search results do not meet search results criteria), the system obtains identification of users via user input.

In an example, obtaining identification of users via user input includes specifically prompting the particular user for identifying users. In another example, a field for users to enter identifications is modified from an inactive state preventing user input to an active state allowing user input. In an example, the system provides all Phoenix Suns found anywhere (removing the geographical search region filter) and allows a user to select the users to interact with from this list.

In an embodiment, a particular user is presented with an option of the system modifying the geographical search area, or entering the identification of users. If a user selects the option to enter identification of users, the system provides an interface for the particular user to enter identification of users. Identification of a user, as referred to herein, includes any type of identifier including but not limited to user names, phone numbers, profile names, email addresses, website identifiers for users, and log-in names.

Once a particular user enters the identification of other users, the system connects the user with the other users by initiating communication. In an example, each other users identified by the particular user receive a message identifying the particular user. In an example, the message includes a challenge or question which prompts the other user to interact with the particular user.

K. System Examples

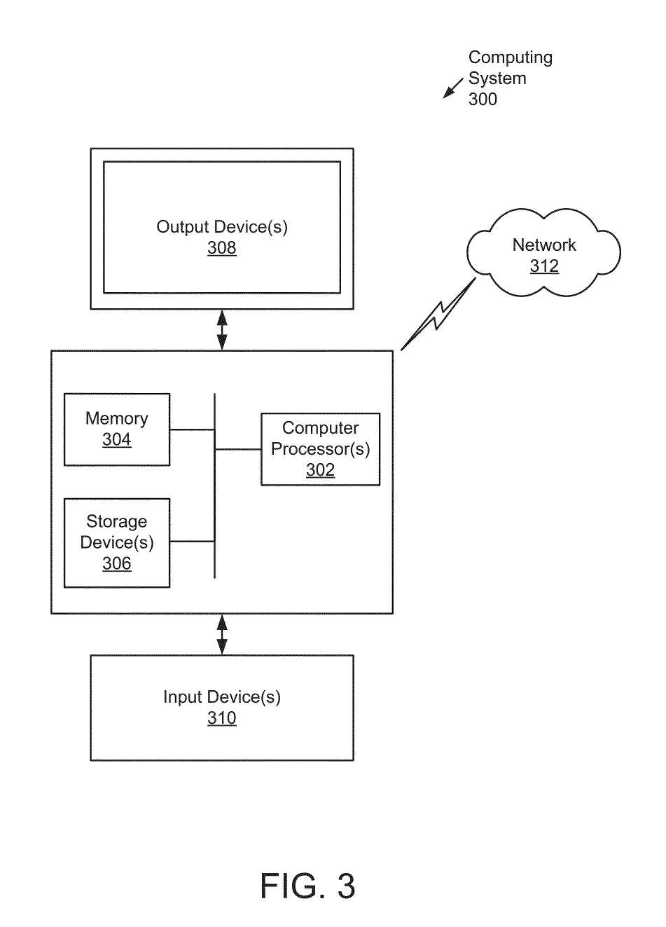

Embodiments may be implemented on virtually any type of computing system regardless of the platform being used. For example, the computing system refers to one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 3, the computing system (300) includes one or more computer processor(s) (302), associated memory (304) (e.g., random access memory (RAM), cache memory, flash memory, etc.), one or more storage device(s) (306) (e.g., a hard disk, an optical drive such as a compact disk (CD) drive or digital versatile disk (DVD) drive, a flash memory stick, etc.), and numerous other elements and functionalities. The computer processor(s) (302) is an integrated circuit for processing instructions. For example, the computer processor(s) includes one or more cores, or micro-cores of a processor. The computing system (300) also includes one or more input device(s) (310), such as a touchscreen, keyboard, mouse, microphone, touchpad, electronic pen, or any other type of input device. Further, the computing system (300) includes one or more output device(s) (308), such as a screen (e.g., a liquid crystal display (LCD), a plasma display, touchscreen, cathode ray tube (CRT) monitor, projector, or other display device), a printer, external storage, or any other output device. One or more of the output device(s) is the same or different from the input device(s). The computing system (300) is connected to a network (312) (e.g., a local area network (LAN), a wide area network (WAN) such as the Internet, mobile network, or any other type of network) via a network interface connection (not shown). The input and output device(s) are locally or remotely connected (e.g., via the network (312)) to the computer processor(s) (302), memory (304), and storage device(s) (306). Many different types of computing systems exist, and the aforementioned input and output device(s) may take other forms.

Software instructions in the form of computer readable program code to perform embodiments are stored, in whole or in part, temporarily or permanently, on a non-transitory computer readable medium such as a CD, DVD, storage device, a diskette, a tape, flash memory, physical memory, or any other computer readable storage medium. In an example, the software instructions correspond to computer readable program code that when executed by a processor(s), is configured to perform embodiments of the invention.

Further, one or more elements of the aforementioned computing system (300) is located at a remote location and connected to the other elements over a network (312). Embodiments of the invention are implemented on a distributed system having a plurality of nodes, where each portion of the invention is located on a different node within the distributed system. In one embodiment of the invention, the node corresponds to a distinct computing device. Alternatively, the node corresponds to a computer processor with associated physical memory. In another example, the node corresponds to a computer processor or micro-core of a computer processor with shared memory and/or resources.

While a limited number of embodiments have been described, those skilled in the art, having benefit of this disclosure, will appreciate that other embodiments can be devised which do not depart from the scope of this patent application. Accordingly, the scope of this patent application should be limited only by the attached claims.

1. A non-transitory computer readable medium comprising instructions which, when executed by one or more hardware processors, causes performance of operations comprising:
receiving a request to execute a first search;
determining a distance that a user is willing to travel on a time of day, day of week, and/or date associated with the first search;
selecting a first geographical search area based on the distance the user is willing to travel on the time of day, day of week, and/or date associated with the first search;
executing the first search to obtain a first set of search results corresponding to the first geographical search region that was selected based the distance the user is willing to travel on the time of day, day of week, and/or date associated with the first search.

2. The medium of claim 1, wherein the operations further comprise:
determining whether the first set of search results meet a search results criteria;
responsive to determining that the first set of search results do not meet the search results criteria, selecting a second geographical search region that includes at least one location not included in the first geographical search region;
executing a second search to obtain a second set of search results corresponding to the second geographical search region.

3. The medium of claim 1, wherein the operations further comprise:
determining whether the first set of search results meet a search results criteria;
responsive to determining that the first set of search results do not meet the search results criteria, selecting a second geographical search region that includes (a) at least one location not included in the first geographical search region and (b) at least one location included in the first geographical search region;
executing a second search to obtain a second set of search results corresponding to the second geographical search region.

4. The medium of claim 1, wherein the operations further comprise selecting new geographical regions for executing additional searches until corresponding search results meet a search results criteria or until a maximum geographical search region is used for obtaining search results.

5. The medium of claim 4, wherein the maximum geographical search region is selected based on attributes of a user for which the search results are being obtained.

6. The medium of claim 1, wherein the first geographical search region is selected based further on a first travel time from a first set of one or more locations associated with a user.

7. The medium of claim 1, wherein the first geographical search region is selected based further on a first travel distance from a first set of one or more locations associated with a user.

8. The medium of claim 1, wherein the first geographical search region consists of locations within a first radial distance from a first set of one or more locations.

9. The medium of claim 1, wherein the first geographical search region is selected to include locations accessible by a user using one or more specified modes of transportation available to the user.

10. The medium of claim 1, wherein the time of day, day of week, and/or date associated with the first search is a time of day, day of week, and/or date of an event associated with the first search.

11. The medium of claim 1, wherein the time of day, day of week, and/or date associated with the first search is a time of day, day of week, and/or date when the first search was executed.

12. The medium of claim 1, wherein the first geographical search region comprises two or more disjoint geographical search regions.

13. The medium of claim 1, wherein the operations further comprises displaying, storing, or transmitting the first set of search results.

14. The medium of claim 1, wherein the first search is executed to search for users that are fans of a particular sports team.

15. The medium of claim 1, wherein the request defines one or more sports teams of interest to a user.

16. The medium of claim 1, wherein a search results criteria identify requirements for the first set of search results, and where the first geographical region is modified if the first set of search results do not meet the search results criteria.

17. The medium of claim 1, wherein the time of day, day of week, and/or date associated with the first search is specified by a user that submits the request to execute the first search.

18. The medium of claim 1, wherein the time of day, day of week,
and/or date associated with the first search is a future time of day, day of week, and/or date relevant to a search criteria corresponding to the first search.

19. A non-transitory computer readable medium comprising instructions which, when executed by one or more hardware processors, causes performance of operations comprising:
receiving, from a particular user or a computing system, a selection identifying a geographical search region including locations within a particular travel time from at least one location associated with the particular user and/or including locations within a particular travel cost from the at least one location;
executing a search to identify a subset, of a plurality of users, that (a) match a particular search criteria and (b) are associated with locations within the geographical search region;
storing or transmitting data identifying the subset of the plurality of users.

20. The medium of claim 19, wherein the geographical search region further includes locations within a particular travel distance from the at least one location.

21. The medium of claim 19, wherein the geographical search region includes locations within the particular travel time from the at least one location.

22. The medium of claim 19, wherein the geographical search region includes locations within the particular travel cost from the at least one location.

23. The medium of claim 19, wherein the geographical search region includes locations, within the particular travel time and/or the particular travel cost, that are accessible from the at least one location via one or more modes of transportation that are available to the particular user.

24. (canceled)

25. (canceled)

26. The medium of claim 19, wherein the at least one location associated with the particular user is determined based on a schedule for the particular user.

27. The medium of claim 19, wherein the at least one location is obtained via user input from the particular user.

28. The medium of claim 19, wherein the at least one location is selected based on one or more prior visits to the at least one location by the particular user.

29. The medium of claim 19, wherein the particular search criteria defines one or more sports teams of interest to the particular user.

30. A non-transitory computer readable medium comprising instructions which, when executed by one or more hardware processors, causes performance of operations comprising:
executing a search to identify search results comprising users corresponding to a first geographical search region;
determining that the search results include an insufficient number of users;
responsive to the determining operation, prompting a user to identify one or more users for engaging in communications with said user, the one or more users not corresponding to the first geographical search region;
transmitting a message to the one or more users, the message comprising an invitation to engage in communications with said user.

31. The medium of claim 30, wherein prompting the user comprises one or more of: presenting a user interface to allow said user to enter identifications of the one or more users or modifying a field to enter identifications of the one or more users from an inactive state preventing user input to an active state allowing for user input.

32. The medium of claim 1, wherein the distance that the user is willing to travel on the time of day, day of week, and/or date associated with the first search is determined based on a user profile corresponding to said user.
